(19) United States
(12) Patent Application Publication
(10) Pub. No.: US 2003/0175584 A1
(43) Pub. Date: Sep. 18, 2003

(54) Battery pack holder for metal-air battery cells

(75) Inventors: Yaron Shrim, Jerusalem (IL); Victor Bogdanovsky, Jerusalem (IL); Jacob Rosenberg, Jerusalem (IL)

Correspondence Address: LYON & LYON LLP, 633 WEST FIFTH STREET, SUITE 4700, LOS ANGELES, CA, 90071, US

(73) Assignee: ELECTRIC FUEL LTD.

(21) Appl. No.: 10/099,711

(22) Filed: Mar. 14, 2002

(51) Int. Cl. H01M 2/10; H01M 2/12; H01M 12/06

(52) U.S. Cl. 429/96; 429/82; 429/27; 29/623.1

(57) ABSTRACT

The battery cell holder securely holds a plurality of electrical cells in a battery pack. The battery cell holder comprises at least two separate types of layers that are bound to each other to form opposing faces. The first layer is made of a material that absorbs aqueous solutions, particularly liquid electrolyte solutions used in metal-air cells, and preferably contacts an outward facing portion of each battery cell in the battery pack. This material acts to limit the spread of leaking electrolyte solution so that the electrolyte solution cannot spread to other cells and cause electrical short circuits between the cells in the battery pack. The second layer is made of a material that is light, flexible, inexpensive, electrically non-conductive and impermeable to liquids. The latter prevents seepage of absorbed electrolyte from the casing. The holder may be made of inexpensive materials and avoid a need for complete encapsulation of the cells.

### FIELD OF THE INVENTION

The present invention relates to battery packs containing electrochemical cells. More particularly, the present invention relates to a battery pack holder for metal-air battery cells having improved leak containment and manufacturing qualities.

### BACKGROUND OF THE INVENTION

Most high-drain portable electronic devices are powered by secondary (i.e., rechargeable) batteries. Examples of such high-drain devices are cellular telephones, notebook computers, camcorders, and cordless hand-tools. Primary (i.e., single use) batteries are undesirable in such applications because the life-span of typical primary batteries is so short, and the cost so high, that they ultimately prove too costly for long-term use. For example, a cellular telephone with alkaline batteries would last about as long as a single charge of a nickel-metal-hydride battery, but in the long term, cost far more per unit of energy. A nickel-metal hydride battery, though initially expensive, costs only pennies to recharge. In addition, the weight of primary batteries discourages a user from carrying enough primary batteries for long-term operation of the device.

New primary battery technologies have emerged that, at least in theory, have the potential to offer sufficient energy and power at a low cost to make these batteries attractive for high-drain portable devices. One such technology is metal-air batteries, exemplified by zinc-air batteries. In a metal-air battery, the metal acts as one of the electrodes, and oxygen derived from ambient air is used as the other electrode. The metal-air battery cell generates power through electrochemical reactions. Typically, metal-air battery cells include an outer casing wall having one or more holes to permit diffusion of oxygen from ambient air. To generate power, an oxygen-reducing catalyst, in an air cathode inside the battery cell, catalyzes the conversion of oxygen to hydroxyl ions. The hydroxyl ions then migrate to the anode where the anode metal oxidizes. Electrons are liberated by the anode and pumped through the load to offset the deficit generated by the oxygen reduction in the cathode.

Typical metal-air cells admit air through holes in their casings. These holes permit oxygen to diffuse into the cell and also permit water vapor to escape. The cells preferably contains holes all throughout the casing, which, because of their cumulative open area and location, ensure adequate oxygen delivery to the cells. Alternatively, a porous plastic or semipermeable membrane or other material, which permit a sufficient air exchange through the battery pack case, may be used in place of battery casing holes.

Since ambient air is used as one of the electrodes, a metal-air battery includes only one consumable electrode. Because of this, the energy capacity per unit weight is greatly increased. Unfortunately, the intrinsic benefits of electrochemical cells that use air as an electrode are attended by some serious technical problems.

Inadvertent blockage of holes on the casing can pose a problem by reducing the supply of oxygen to the cell. To alleviate this problem, the battery cell casing must have air access openings of sufficient area to supply the required air flow. However, the air access openings can also lead to loss of electrolyte, due to evaporation (cell dryout), which can cause a cell to stop functioning before complete discharge. The loss of water from inside the cells is caused by a higher partial pressure of water (ppH₂O) on the interior of the cell than on the exterior of the cell. Under such conditions, moisture will diffuse through the air access holes. Since the ppH₂O inside the battery cell is usually greater than the ppH₂O of the atmosphere, moisture normally diffuses out of the cell. In addition to causing cell dryout, this moisture loss can produce electrical short circuits with neighboring cells in a multi-cell battery pack.

To reduce dryout, the sizing of the air access holes on the gas-exchange wall of the cell is designed so as to strike the most favorable balance between the demand for oxygen and inhibition of evaporative loss of water from the battery cell. This balance is struck by making the hole size as small as practical, and by spacing the holes as far apart as possible without substantially reducing the efficacy of the battery cell's oxygen uptake. Larger holes would permit increased air flow but would do so at the cost of a higher risk of leaks and electrical short circuits.

For metal-air batteries to provide higher power, larger amounts of oxygen must pass into the cells (up to 0.0032 cc/sec/cm²). This creates design problems for hand-held consumer electronic devices. Small portable electronic devices provide little surface area for air access. Moreover, the metal-air battery cells themselves must be designed so as to ensure adequate oxygen delivery through the cell. For larger batteries with higher power capacity, multiple cells must be used. Such cells typically are arranged in a plastic tray for assembly into a multi-cell battery pack or a multi-level, multi-cell battery pack. The tray supports the cells and prevents inter-cell short circuits. Each cell face is then covered with a liquid impermeable material, i.e., a sheet made of Teflon® or a similar material, to contain electrolyte leaks while permitting air to diffuse into the cells. However, such an arrangement is undesirable for several reasons. First, the material used to cover the cells is costly. Second, the conventional arrangements of battery packs are cumbersome and inconvenient to assemble, because inter-cell electrical connections must pass through or around the plastic trays. Lastly, while the liquid impermeable sheet prevents cell-to-cell contact, they cannot prevent moisture from seeping among the cells and causing cell dryout and electrical short circuits.

Accordingly, there is a need for a means for assembling cells in a multi-cell pack that is inexpensive and prevents cell-to-cell contact while minimizing and absorbing liquid electrolyte that leaks from the cells. One method described in a related application for patent encapsulates cells in an aqueous-impermeable tray. This process can involve some expensive materials and manufacturing steps such as welding an enclosure. There is thus a need for a cheap and simple alternative that can reliably achieve the protection against spillage of electrolyte that is achieved by hermetic encapsulation of the cells.

### SUMMARY OF THE INVENTION

The battery cell holder of the present invention is constructed to securely hold a plurality of electrical cells in a battery pack. The battery cell holder comprises at least two separate types of layers that are bound to each other to form opposing faces. The first layer is made of a material that is absorbtive to aqueous solutions, particularly liquid electrolyte solutions used in metal-air cells. This first layer preferably is in contact with an outward facing portion of each battery cell in the battery pack. This material acts to limit the spread of leaking electrolyte solution so that the electrolyte solution cannot spread to other cells and cause electrical short circuits between the cells in the battery pack. The second layer is made of a material that is light, flexible, inexpensive, electrically non-conductive and impermeable to liquids. This material acts to isolate the individual cells and maintain the integrity of the battery pack.

It is especially preferred to arrange the holder with a series of flaps that surround the battery cells. These flaps overlap the cells in such a manner as to length the path of any short due to electrolyte leaks from the cells. Moreover, the continuous wrapping of the cells means that any electrolyte leaks will be spread over the entire surface of the absorbtive material, and will not pool at the point of the leak. The holder also may formed as a single piece (i.e., by stamping or cutting multiple copies from a single piece of stock material) and folded into the desired shape for holding the battery cells.

Accordingly, it is an object of the present invention to provide a metal-air battery cell holder for housing a plurality of metal-air battery cells, wherein the holder is configured to support each of the plurality of metal-air battery cells in a predefined position inside the case; the holder having a first layer and a second layer; the first layer being impermeable to aqueous liquids and electrically insulating; the second layer being absorbent to the aqueous liquids; and the second layer being located between the plurality of metal-air battery cells and the first layer.

The invention will be described in connection with certain preferred embodiments, with reference to the following illustrative figures so that it may be more fully understood. With reference to the figures, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWINGS

FIG. 1 is a perspective view of a conventional prismatic metal-air battery cell.

FIG. 2A is a drawing of a planar development of a battery holder, the planar development being folded to form the battery holder structure, according to a first embodiment of the present invention.

FIG. 2B is a schematic illustration of a portion of a planar material with a water-absorbing surface and a water-impermeable surface used in various embodiments of the invention.

FIG. 3A is a drawing of the embodiment of FIG. 2A in combination with a plurality of metal-air battery cells, showing the alignment of the battery cells within a holder according to an embodiment of the present invention.

FIG. 3B is a drawing of the embodiment of FIG. 2 in combination with a plurality of metal-air battery cells, showing the alignment of the battery cells within the holder of the present invention when a battery holder is folded over onto itself.

FIG. 4 is a drawing of a battery holder according to a further embodiment of the present invention.

### DETAILED DESCRIPTION OF THE PREFERRED EMBODIMENT

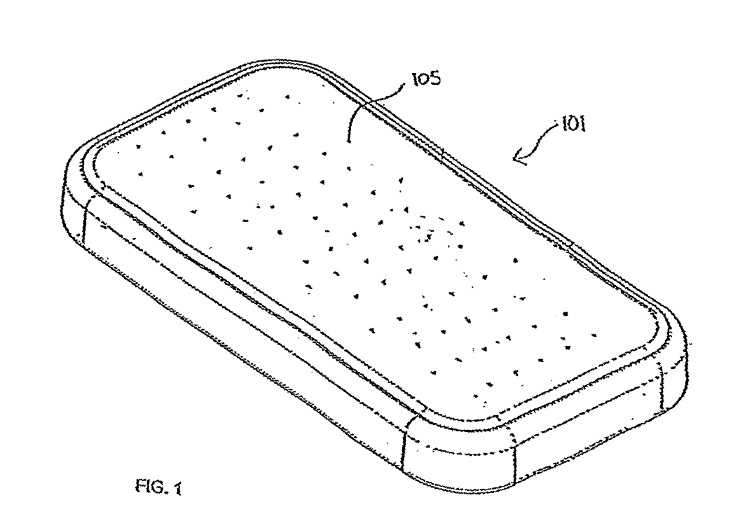

The present invention provides a battery cell holder for use with metal/air battery cells, such as zinc-air cells. Referring to FIG. 1, a metal-air battery cell 101 has a casing with air access openings 105 for ingress and egress of air through the casing. Air ingress is required for proper operation of metal-air battery cell 101. A plurality of metal-air battery cells 101 can be electrically connected and housed in a battery casing to form a battery pack. Note that although a prism-shaped cell is shown, other shapes are known and can be used in connection with the holder embodiments to be described herein. For example, the most common shape is a cylindrical one commonly referred to as button cells.

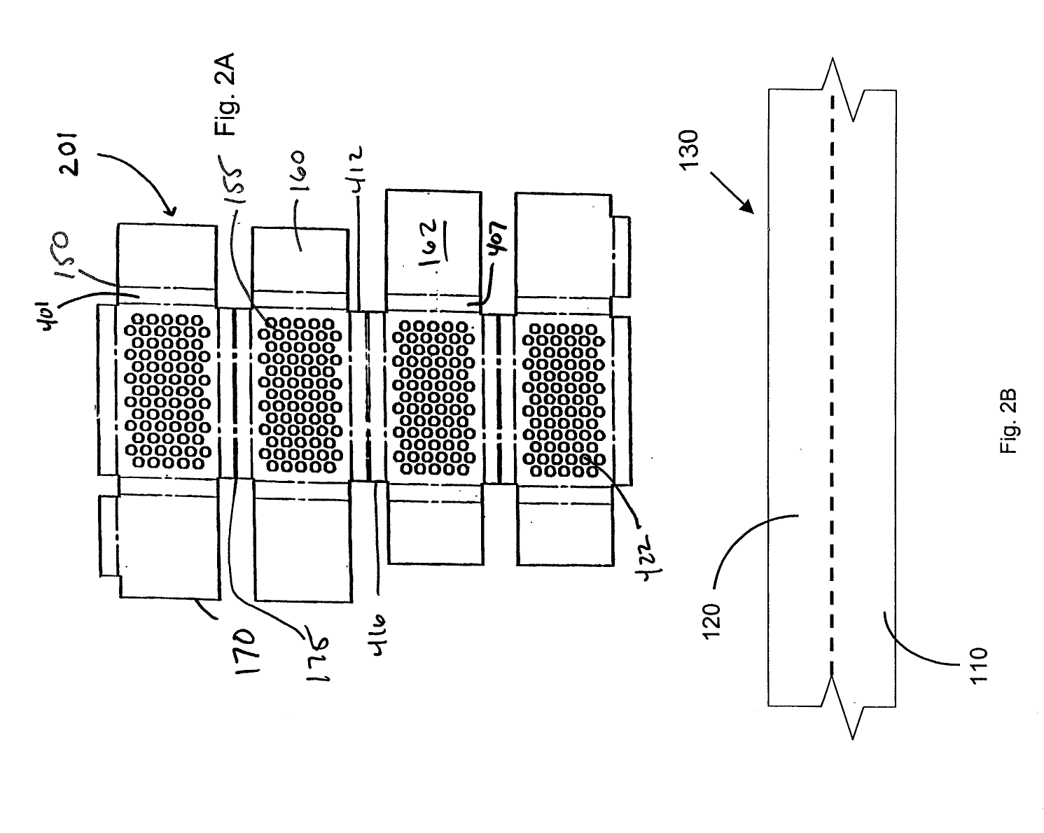

Referring to FIG. 2B, a portion of a flat planar material 130 has an impermeable surface 110 and an absorbing surface 120. The material 130 is used to form a support structure for battery cells such as battery cell 101. The impermeable surface 110 acts as a barrier to the flow of electrolyte completely through the material 130. The absorbing surface 120 traps and holds electrolyte that may leak due to a malfunction of the battery cell (e.g., battery cell 101). In a preferred embodiment of the present invention, the material 130 may be folded to form a support structure (embodiments shown and discussed below) for battery cells (e.g. cell 101) with the absorbing surface 120 facing the cells and the impermeable surface 120 facing away from the cells. By suitable punching of air access holes and folding, it is possible to nearly or completely wrap the cells, providing a diaper of sorts to prevent any leakage of electrolyte from within. Also, the material 130 may be made of inexpensive materials such as blotter paper, cardboard, etc. treated to give the opposing surfaces the impermeable and absorbing properties of material 130. Alternatively it may be made from a laminar structure having two or more layers. For example, the material could include an absorbing core surrounded by an impermeable veneer that is punched on one side to form the absorbing surface 120. FIG. 2A is intended to be figurative and not representative of any preferred thicknesses or ratios thereof or even a number of materials that may be involved in making the material 130 structure. In addition to being impermeable, the impermeable surface 110 is also, preferably, electrically insulating.

“Folded” as used herein may define not only a process producing certain structural properties such as sharp bends or curves. Folded materials generally exhibit certain structural evidence of having been formed by the process of folding. In particular, a planar material, including a curvilinear-planar material such as obtained from a roll, must be curved sharply. If the curving goes beyond the elastic limit of the material, then the stress of curving will be relieved. The result will be that the material will generally display evidence of the yielding. The sheet material could also be held in a frame in which case the elastic limit may not need to be overcome. Of course there is a continuum between the two extremes and most real materials would fall into one or the other. In either case, a folded material exhibits particular properties due to the overcoming of the elastic limit or the presence of elastic stress.

If a material is folded and then temporarily subjected to a condition that causes stress to be relaxed, the effect may be to create a result that exhibits neither the presence of elastic stress nor evidence of yielding to a strain that went beyond the elastic limit such as when paper is folded. Thus, as used herein, the term “folded” as applied to a material (i.e., a result) may encompass structures that exhibit evidence of having been folded, including stress and a result of yielding. The term “folded” as applied to a process for making may include any type of process where a material is curved more than an initial degree.

Various techniques may be used to create the basic material 130. The absorbent part may be made of an inexpensive, absorbent foam or woven or non-woven cloth, such as a cotton cloth or felt. Alternately, the first layer may be made of paper or cardboard. The absorbent material may also include an absorbent, loosely packed material or a sponge. The absorbent material preferably has at least the following features: inexpensive, capable of absorbing as much moisture as may escape from the cells; and capable of being bound to the second material. The impermeable material may be laminated or glued onto a surface of an absorbent layer, creating a two-sided sheet that can be folded or bent to create trays in which to hold the metal-air cells.

Some examples of material 130 are:

1. Absorbent paper or cardboard with an impermeable coating on one side, particularly, for example, a resin-based coating that is electrically insulating and, possibly adding structural strength to the material 130.

2. A soft absorbent material laminated to a stiff veneer of insulating and impermeable material such as any of various polymer materials or closed cell foam plastics. The soft absorbent material may be blotter paper, fabric, non-woven fabric, paper, and may incorporate divided material that enhances absorption such as a cellulosic material impregnated therein.

3. A structural impermeable and insulating material (e.g. plastic) coated on one surface with an absorbent material such as cellulosic material with a binder to give the material some integrity.

4. A polymer or other material that is mechanically treated to make it absorbing on one side such as a wettable, but impermeable monolithic material that is sintered on one side to make that side absorbent.

5. A sandwich of impermeable layers enveloping an absorbent core with perforations on one side to make that side absorbent.

Note that although the discussion above assumes a material 130 that is absorbent on one side and impermeable on the other, it is clear that the material 130 could also be absorbent on both sides and still be impermeable to flow completely through the material 130. So, for example, an impermeable material coated on both sides with an absorbing material would also work in the invention, but it is preferred that the bulk of the absorbent material be on one side in situations where the material is folded to produce the cell support. This is because by using the most convenient and efficient manners of folding the material to envelop the cells, as will become clear from examples below, only one side of the material 130 generally faces a given cell. By putting the absorbent material adjacent the cell and placing an impermeable layer between a casing holding the support and the cell, it is believed the most favorable arrangement is formed for guarding against spillage of electrolyte from the casing.

Referring now also to FIG. 2A, a battery cell holder 201 is made of a material 170 that conforms to the description attending FIG. 2B. That is, the material 170 absorbs aqueous solutions, in particular the aqueous solutions used as liquid electrolytes in metal-air electrical cells. The material 170 has opposing surfaces, one of which is electrically insulating and also impermeable to aqueous solutions and the other which is absorbing. The material 170 is cut out to form a cutout 201 with various portions 160 that may be folded along various contours 150 to envelop cells (not shown in FIG. 2A) such that the absorbent surface faces at least a portion of a casing wall of at least one cell in a battery pack having a plurality of metal-air cells. The impermeable surfaces face the outside when the cutout 201 is folded. The cutout 201 is preferably punched to create a perforated face 155 to allow air to diffuse through the perforated faces 155 of the cutout 201. In this way, the cells may be completely surrounded by the material 170 except for just the parts that are punched out.

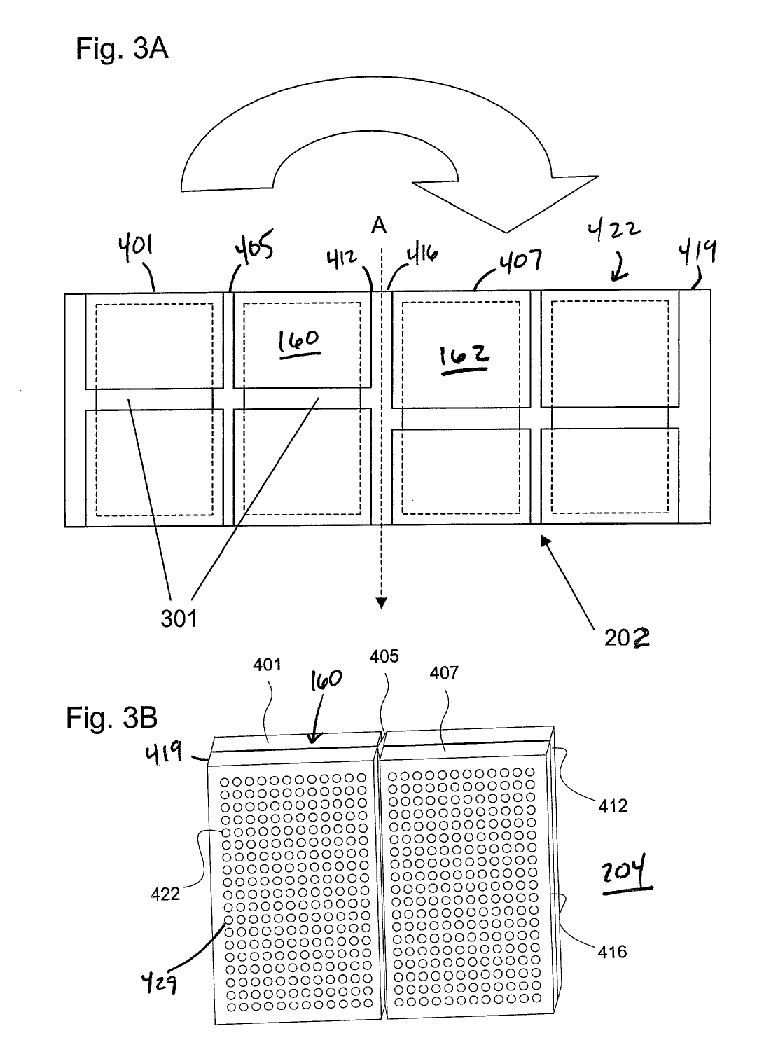

Referring to FIGS. 3A and 3B, the cutout 201 may be folded in stages shown at FIGS. 3A and 3B respectively to form a holder 204 for holding one or more metal-air cells 301. The material may be bent or folded as required to form many different configurations, the one shown here being one possibility. The holder 204 may also be produced from a plurality of pieces, any of which may be bent or folded as required to maintain the absorbent portion in proximity to the surfaces of the battery cell(s) 301. FIG. 3A shows the holder 204 in a partial state of folding 202. Various portions 401, 405, 412, 416, 419, 160, and 162 are marked so that it can be seen how each cell is ultimately enveloped by the material 170 with each cell electrically insulated from adjacent cells by respective flaps (e.g., 160 and 162) which cannot be seen in FIG. 3B because they are sandwiched between adjacent cells 301.

Electrical connection among the cells that make up the battery may be accomplished by any of a number of methods well known to those in the art. For example, the cells may be connected using electrical wires that are spot-welded or soldered at each end to a different cell to join one cell to the next. Alternatively, the cells may be connected using a single electrically conductive material in an internal support structure.

When arranging cells inside the holder, as many cells as possible should be oriented so that their air access openings face the exterior and are in contact with the holder. A single cell may have more than one surface bearing air access openings. Preferably, all the cells of the battery face the exterior. However, the number of cells needed to generate the necessary level of current and voltage and to hold a sufficient quantity of energy, together with the form-factor requirements, may make it impossible for a designer to orient the cells so that they all face the exterior. The short distance between the gas-exchange walls and the ambient air coupled with the abundance of air access openings on the cells should ensure that air can passively diffuse at a rate adequate to satisfy the oxygen requirements of the cells. Additionally, or in the alternative, cells can be added and arranged to define internal plenums within the housing. Ventilation holes on opposite sides of the plenum permit bulk flow as well as a diffusion of air so that sufficient oxygen can reach every cell.

The holder 204 contains a number of holes 429 which may spatially match the locations of the air access openings in the battery cell casings. In this manner, air can freely diffuse through the holder to the air access openings 105 of the cells 101. Alternatively, the holes 429 may be large enough that most of the openings 105 will have access to air. The holes in the holder 204 may be of any shape or size effective to promote adequate ventilation of the cells held therein. For example, the holes 429 may be round, square or of any geometric shape. Alternatively, the ventilation holes may be in the form of slots or channels with or without walls to hold the cells away from the holder. The cells 101 may be any type of battery cell and metal-air cells are only used as an example in this specification.

The holder of the present invention is preferably in the form of a single sheet (e.g., 170 that can be folded to chambers for holding battery cells. In the embodiment of FIGS. 3A and 3B, the holder 204 includes four chambers (not shown explicitly) to hold four battery cells 301. Note that in the configuration of FIGS. 3A and 3B, the holder 204 arranges the cells so that they all face outwardly. A casing (not shown) with holes in it can then support the holder 204 and cells so that gases need diffuse only a minimal distance. Note that a diffuser or gas-permeable material may be used in place of or over the holes 429 and still permit diffusion to occur.

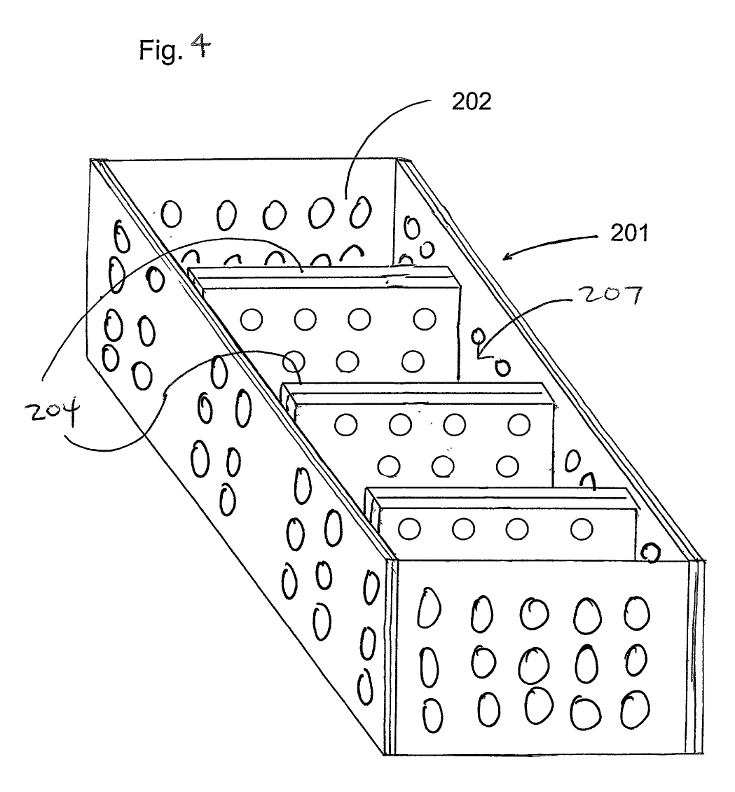

The holder 204 configuration permits multiple holders 204 with cells therein to be stacked upon one another with air gaps 207 between them as shown in FIG. 4. In an alternative embodiment (not shown), the pairs are not stacked upon one another, but rather are spread out in a single layer. This arrangement maximizes the number of cells 301 that may be directly exposed to ambient air without the need to create internal air channels 207. In other embodiments, additional pairs of slots for cells 301 could be added to the holder to accommodate six, eight, ten or more cells 301. In still other embodiments, holders for a single cell 301 could be added as required to attain an odd number of cells 301.

Referring again to FIGS. 2A and 3A, it is preferred that the flaps (e.g., 106) permit the material 170 to surround the battery cells 301 at least partially. As shown clearly, these flaps 106 may be cut in different lengths so that a zigzag path is defined between adjacent cells to lengthen a path of wetted material to reduce the current in any short resulting from leakage of electrolyte. Moreover, the wrapping of the cells 301 helps to ensure that any electrolyte leaks will be spread over the entire surface of the absorbent material, and will not pool at the point of the leak.

In the embodiment of FIG. 4, an external holder 201 is made of the insulating, absorbent, and impermeable material 202. The external holder 201 may have holes in it to allow air to circulate in the spaces 207. Inserts (not shown) may be placed between the holder/cell units 204 in the external holder 201 to separate the banks of cells. The inserts preferably comprise the material 130. The space 207 between the cells may be preferably in the range of 0.5 mm to 2.5 mm.

To provide for the secure placement of multiple metal-air battery cells in a tray, the battery cells may be held in place by an internal support structure (not shown) that separates the battery cells and keeps them from moving within the holder. The compartments may also have projections that secure the battery cells by a snap-fit. The compartments may further have projections that serve to electrically connect the cells to each other. The structure may then be securely connected to the battery pack case. Alternatively, the battery holder itself may be provided with a plurality of projections that allow the individual metal-air battery cells, or the structure containing the plurality of battery cells, to snap in place. In this case, the holder also may have projections that serve to electrically connect the cells. Battery cell compartments can also be joined by a living hinge with each compartment containing standoffs to aid in the separation of the battery cells. To alleviate the problem due to the inevitable expansion of the metal-air battery cells (e.g., due to zinc-oxide formation in the case of a zinc-air cell), the support structure can be flexible so as to accommodate changes in the shape of the battery cells.

The tray or holder may also incorporate one or more diffusing elements (not shown) located beside or in physical contact with the battery cells. The diffusing element is formed of a material such that a gas exchange through the diffusing elements and between the respective battery cells and an outside of the case is permitted. The diffusing element may be positioned between the battery cell surface with air holes and the holder such that the battery cell surface with air holes is separated from the holder. Alternatively, the diffusing element may be outside the electrically insulating second material, or it may be located between the liquid absorbent first material and the electrically insulating second material. The diffusing element is preferably formed of a material such that a gas exchange through the diffusing element and between an outside of the case element and the battery cell is permitted. The diffusing element may contact the surface of the at least one of the battery cells.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A metal-air battery cell holder for holding at least one battery cell, said holder comprising:
a foldable sheet having a first portion that is substantially aqueous-absorbent, and a second portion that is substantially electrically insulating and aqueous-impermeable;
said sheet being folded into a shape defining at least one recess sized and shaped to accommodate at least a majority of an external surface of said at least one battery cell; and
said sheet being formed such that, when holding said at least one cell, moisture leaking from said at least one cell is absorbed by said first portion and substantially isolated by said second portion.

2. The holder of claim 1, wherein said first portion is an aqueous absorbing surface of said sheet, and said second portion is an impermeable surface of said sheet, and at least a majority of said aqueous-absorbing surface is oriented to face said at least one cell and at least a majority of said impermeable surface faces away from said at least one cell.

3. The holder of claim 1, wherein said sheet is sized and shaped such that said at least one cell is substantially encased by said sheet.

4. The holder of claim 1, wherein said at least one cell includes a metal-air battery cell and said sheet has air-permeable regions that, when said sheet is folded to hold said at least one cell, align with air access openings in said metal-air battery cell.

5. The holder of claim 4, wherein said air-permeable regions are holes.

6. The holder of claim 1, wherein said sheet includes paper or cardboard.

7. The holder of claim 1, wherein said sheet includes felt, sponge, cotton cloth, paper or cardboard.

8. The holder of claim 1, wherein said sheet includes at least one layer of insulating plastic material.

9. The holder of claim 8, wherein said plastic material includes polyethylene, polypropylene, or polystyrene.

10. The holder of claim 1, wherein said sheet is a laminate including at least one layer of aqueous absorbent material and at least one layer of impermeable material.

11. The holder of claim 1, wherein said at least one cell includes cells and said sheet is sized and shaped such that, when folded to hold said cells and when said aqueous-absorbent surface is wetted, a wetted path is defined between adjacent ones of said cells that is substantially longer than a minimum distance between said cells, whereby a short-circuit current potential is reduced.

12. A metal-air battery cell holder for holding at least one battery cell, comprising:
said holding device having a portion including a sheet that is folded into a shape capable of at least partially surrounding said at least one battery cell;
said portion being substantially electrically insulating and aqueous-impermeable; and
said portion being in contact with said at least one battery cell and being effective to retain an aqueous solution in the event of leakage from said at least one battery cell.

13. A metal-air battery cell holder according to claim 12, wherein said at least one cell includes a metal-air battery cell having air access openings and said holding device has a gas exchange portion permitting exchange of gases that align with said air access openings in said metal-air battery cell to permit exchange of gases with an ambient atmosphere.

14. A metal-air battery cell holder according to claim 13, wherein said gas exchange portion includes holes.

15. A metal-air battery cell holder according to claim 12, wherein said second portion comprises an absorbent material.

16. A metal-air battery cell holder according to claim 15, wherein said absorbent material is distributed upon at least one surface of said sheet.

17. A metal-air battery cell holder according to claim 16, wherein said absorbent material is substantially restricted to a single side surface of said sheet.

18. A metal-air battery housing portion for preventing leakage from at least one battery cell, said holder comprising:
a folded sheet capable of at least partially surrounding said at least one battery cell;
a first portion of said sheet being substantially electrically insulating and aqueous-impermeable;
a second portion of said sheet being made of an absorbent material effective to retain an aqueous solution.

19. A metal-air battery cell holder according to claim 18, wherein said housing portion supports said at least one battery cell in a predefined position within a casing.

20. A metal-air battery cell housing portion according to claim 18, wherein said at least one cell includes a metal-air battery cell having air access openings and said holder has a portion permitting exchange of gases that, when said holder is arranged to hold said at least one cell, aligns with said air access openings in said metal-air battery cell.

21. A metal-air battery cell housing portion according to claim 20, wherein said portion permitting gas exchange includes holes.

22. A metal-air battery cell housing portion according to claim 18, wherein said holder includes paper or cardboard.

23. A metal-air battery cell housing portion according to claim 18, wherein said holder includes a laminate of plastic and at least one of paper and cardboard.

24. A metal-air battery cell housing portion according to claim 18, wherein said absorbent material comprises one surface of said sheet, and said holder includes paper or cardboard.

25. A metal-air battery cell housing portion for holding at least one battery cell, said housing portion comprising:
a folded sheet capable of at least partially surrounding said at least one battery cell;
said sheet being effective to retain an aqueous solution;
said sheet supporting said at least one battery cell in a predefined position within a casing.

26. A metal-air battery cell housing portion according to claim 25, wherein said sheet is substantially impermeable to said aqueous solution.

27. A metal-air battery cell housing portion according to claim 25, wherein said sheet is a portion of said housing portion.

28. A metal-air battery cell housing portion according to claim 25, wherein said sheet includes at least one layer of insulating plastic material.

29. A metal-air battery cell housing portion according to claim 28, wherein said plastic material includes polyethylene, polypropylene, or polystyrene.

30. A metal-air battery housing portion for preventing leakage from at least one battery cell, said holder comprising:
a folded sheet capable of at least partially contacting said at least one battery cell;
a first portion of said sheet being substantially electrically insulating and aqueous-impermeable;
a second portion of said sheet being made of an absorbent material effective to retain an aqueous solution.

31. A metal-air battery cell holder according to claim 30, wherein said housing portion supports said at least one battery cell in a predefined position within a casing.

32. A metal-air battery cell housing portion according to claim 30, wherein said at least one cell includes a metal-air battery cell having air access openings and said holder has a portion permitting exchange of gases that, when said holder is arranged to hold said at least one cell, aligns with said air access openings in said metal-air battery cell.

33. A metal-air battery cell housing portion according to claim 32, wherein said portion permitting gas exchange includes holes.

34. A metal-air battery cell housing portion according to claim 30, wherein said holder includes paper or cardboard.

35. A metal-air battery cell housing portion according to claim 30, wherein said holder includes a laminate of plastic and at least one of paper and cardboard.

36. A metal-air battery cell housing portion according to claim 30, wherein said absorbent material comprises one surface of said sheet, and said holder includes paper or cardboard.

37. A method of forming a metal-air battery cell holder, comprising the steps of:
obtaining a foldable sheet having a first portion that is substantially aqueous-absorbent, and a second portion that is substantially electrically insulating and aqueous-impermeable; and
folding said foldable sheet into a shape defining at least one recess sized and shaped to accommodate at least a majority of an external surface of said at least one battery cell;
said shape of said foldable sheet further being such that moisture leaking from said at least one cell is absorbed by said first portion and substantially isolated by said second portion.

38. The method of claim 37, wherein said first portion is an aqueous absorbing surface of said sheet, and said second portion is an impermeable surface of said sheet, and at least a majority of said aqueous-absorbing surface is oriented to face said at least one cell and at least a majority of said impermeable surface faces away from said at least one cell.

39. The method of claim 37, further comprising sizing and shaping said foldable sheet such that said at least one cell is substantially encased by said sheet.

40. The method of claim 37, further comprising aligning air-permeable regions in said sheet with air access openings in said metal-air battery cell.

41. The method of claim 40, wherein said air-permeable regions are holes.

42. The method of claim 37, wherein said sheet includes paper or cardboard.

43. The method of claim 37, wherein said sheet includes felt, sponge, cotton cloth, paper or cardboard.

44. The method of claim 37, wherein said sheet includes at least one layer of insulating plastic material.

45. The method of claim 44, wherein said plastic material includes polyethylene, polypropylene, or polystyrene.

46. The method of claim 37 wherein said sheet is a laminate including at least one layer of aqueous absorbent material and at least one layer of impermeable material.

47. The method of claim 37, further comprising folding and shaping said foldable sheet into a shape such that, when folded to hold a plurality of said cells and when said aqueous-absorbent surface is wetted, a wetted path is defined between adjacent ones of said cells that is substantially longer than a minimum distance between said cells, whereby a short-circuit current potential is reduced.
